(19) United States
(12) Patent Application Publication
(10) Pub. No.: US 2007/0141420 A1
(43) Pub. Date: Jun. 21, 2007

(54) Fuel cell thermal management system and method

(76) Inventors: Mark G. Voss, Franksville, WI (US); F. Nelson Jarrett, Racine, WI (US); Joseph R. Stevenson, Kenosha, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/311,645

(22) Filed: Dec. 19, 2005

(51) Int. Cl. H01M 8/04

(52) U.S. Cl. 429/26; 429/24; 429/34

(57) ABSTRACT

A fuel cell thermal management system (10) is provided for maintaining a fuel cell stack (12) within a desired operating temperature range. The system (10) includes a thermal storage reservoir (14), a radiator (16), and a mixing valve (18). Heat from the fuel cell stack (12) is rejected to the thermal storage reservoir (14), and heat from the reservoir (14) is rejected to ambient in the radiator (16). The mixing valve (18) receives a coolant flow from the fuel cell stack (12) at a first temperature T1 and a coolant flow from the radiator (16) or the reservoir (14) at a second temperature T2 and mixes the two coolant flow together to provide a mixed coolant flow to the stack (12) at a third temperature T3 to maintain the stack (12) within its desired operating temperature range.

### FIELD OF THE INVENTION

The invention is directed in general to the fuel cell thermal management of fuel cell stacks.

### BACKGROUND OF THE INVENTION

For optimum performance, it is desirable to maintain the operating temperature of the fuel cell stack within a desired temperature range. This becomes more difficult during transient operation of the fuel cell stack, such as resulting from an increase or decrease in the power demand from the fuel cell stack, particularly when the transient operation results in a rapid increase in the heat generation of the fuel cell stack.

### SUMMARY OF THE INVENTION

In accordance with one feature of the invention, a fuel cell thermal management system is provided for use in maintaining a fuel cell stack within a desired operating temperature range. The system includes a fuel cell stack; a thermal storage reservoir for storing thermal energy rejected from a coolant flow received from the fuel cell stack, the reservoir containing a thermal mass; a radiator to reject heat from a coolant flow received from the thermal storage reservoir; and a mixing valve connected to the fuel cell stack to receive a coolant flow at a first temperature therefrom, to one of the reservoir and the radiator to receive a coolant flow at a second temperature therefrom, and to the fuel cell stack to supply a mixed coolant flow at a third temperature thereto.

According to one feature, the fuel cell thermal management system further includes a first coolant loop directing a first coolant flow through the radiator and the reservoir; and a second coolant loop directing a second coolant flow through the reservoir, the fuel cell stack, and the mixing valve. The mixing valve receives the coolant flow at the second temperature from the reservoir.

As one feature, the reservoir further includes an indirect contact heat exchanger for transferring heat between at least one of the coolant loops and the thermal mass.

In accordance with one feature, the fuel cell thermal management system further includes a coolant loop directing a common coolant flow through the radiator, the reservoir, the fuel cell stack, and the mixing valve, with the mixing valve receiving the coolant flow at the first temperature from the radiator.

As one feature, the fuel cell thermal management system further includes a temperature sensor for sensing a temperature of a coolant flow exiting the fuel cell stack. The mixing valve is configured to adjust a composition of the mixed coolant flow in responsive to a signal from the temperature sensor.

According to one feature, the thermal mass includes a phase-change material having a melting temperature selected to correspond to the desired operating temperature range. As a further feature, the reservoir further includes an indirect contact heat exchanger for transferring heat from a coolant flow to the phase-change material.

In one feature, the thermal mass includes liquid coolant that can mix with the coolant flow supplied to at least one of the radiator and the fuel cell stack.

In accordance with one feature of the invention a fuel cell thermal management system is provided for use in maintaining a fuel cell within a desired operating temperature range. The system includes a fuel cell stack; a thermal storage reservoir for storing thermal energy rejected from a first coolant flow received from the fuel cell stack, the reservoir containing a thermal mass; a radiator to reject heat from a second coolant flow received from the thermal storage reservoir; and a mixing valve connected to the fuel cell stack to receive a coolant flow at a first temperature therefrom, to the reservoir to receive a coolant flow at a second temperature therefrom, and to the fuel cell stack to supply a mixed coolant flow at a third temperature thereto.

As one feature, the fuel cell thermal management system further includes a first coolant loop directing a first coolant flow through the radiator and the reservoir; and a second coolant loop directing a second coolant flow through the reservoir, the fuel cell stack, and the mixing valve.

In accordance with one feature of the invention, a fuel cell thermal management method is provided for maintaining a fuel cell stack within a desired operating temperature range. The method including the steps of:

transferring heat from a first coolant flow to a thermal mass;

transferring heat from the thermal mass to a second coolant flow;

rejecting heat from the second coolant flow;

mixing one of the first and second coolant flows with a third coolant flow from the fuel cell stack to create a mixed coolant flow;

transferring heat from the fuel cell stack to the mixed coolant flow; and

splitting the mixed coolant flow into the first coolant flow and the third coolant flow.

As one feature, the mixing step includes adjusting the composition of the mixed coolant flow based on a sensed temperature representative of the fuel cell stack operating temperature.

According to one feature, the step of transferring heat from a first coolant flow to a thermal mass includes changing a phase of at least a portion of the thermal mass.

In one feature, the step of transferring heat from the thermal mass to a second coolant flow includes changing a phase of at least a portion of the thermal mass.

Other objects, features, and advantages of the invention will become apparent from a review of the entire specification, including the appended claims and drawings.

### BRIEF DESCRIPTION OF THE DRAWINGS

FIG. 1 is a diagrammatic representation of a fuel cell thermal management system embodying the present invention; and

FIG. 2 is a diagrammatic representation of another embodiment of a fuel cell thermal management system embodying the invention.

### DETAILED DESCRIPTION OF THE PREFERRED EMBODIMENT

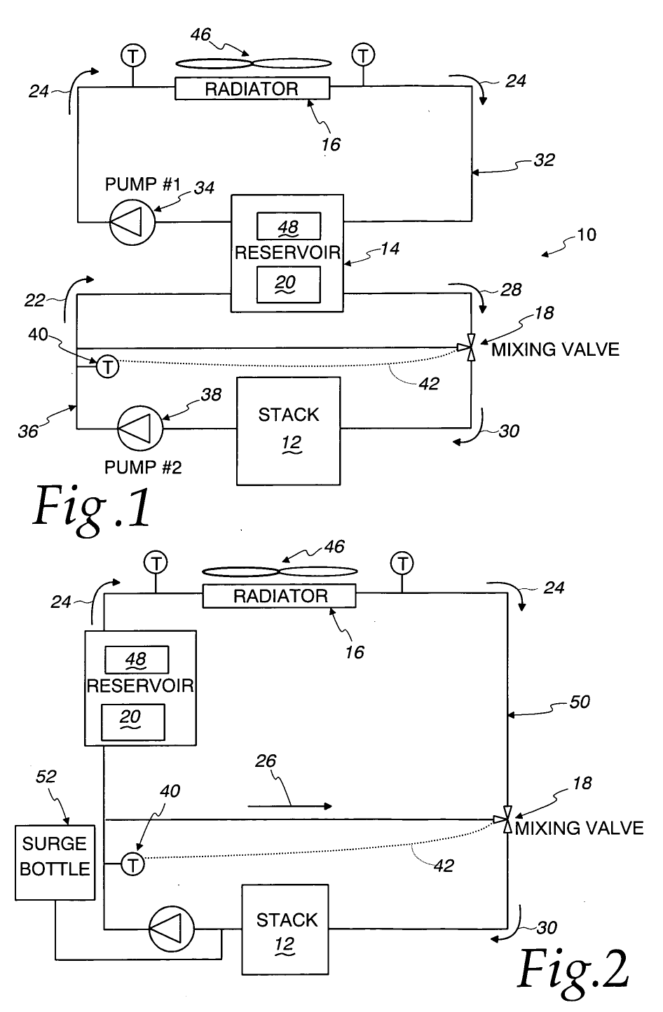

A fuel cell thermal management system 10 is shown in FIG. 1 and is provided for maintaining a fuel cell stack 12 within a desired operating temperature range. The system 10 includes a thermal storage reservoir 14, a radiator 16, and a mixing valve 18.

The thermal storage reservoir 14 contains a thermal mass, shown schematically at 20, and is provided to store thermal energy rejected from a coolant flow, shown schematically by the arrow 22, received from the fuel cell stack 12. The radiator 16 rejects heat from a coolant flow, shown schematically by the arrows 24, received from the thermal storage reservoir 14. The mixing valve 18 is connected to the fuel cell stack 12 to receive a coolant flow, shown schematically by the arrow 26, at a first temperature T1; to the reservoir 14 to receive a coolant flow, shown schematically by the arrow 28, at a second temperature T2; and to the fuel cell stack 12 to supply a mixed coolant flow, shown schematically by the arrow 30, at a third temperature T3.

A first coolant loop 32 directed the first coolant flow 24 through the radiator 16 and the reservoir 14, and includes a pump 34. A second coolant loop 36 directs the coolants flows 22, 26, 28 and 30 through the reservoir 14, mixing valve 18, and fuel cell stack 12, respectively, and includes a pump 38.

The system also preferably includes a temperature sensor 40 that senses the temperature of the mixed coolant flow 30 after it exits the fuel cell stack 12 and provides a signal, shown schematically at 42, to the mixing valve indicative of the sensed temperature. The mixing valve 18 may be any suitable mixing valve 18 that is configured to adjust the composition of the mixed coolant flow 30 by adjusting the relative mixture of the two incoming coolant flows 26 and 28, thereby adjusting the temperature T3, in response to the signal 42 from the sensor 40.

The system can also include a fan 46 that directs a cooling fluid flow, preferably air, through the radiator 16.

In one preferred form, the reservoir 14 is a liquid reservoir and the thermal mass 20 includes a volume of coolant, with at least one of the coolant loops 32 and 36 circulating coolant from the thermal mass 20 through the loop. In some embodiments, both of the coolant loops 32 and 36 will circulate coolant from the thermal mass 20 through their respective loops, while in other embodiments, an indirect contact heat exchanger, shown schematically at 48, can be incorporated within the reservoir 14, with the coolant of the thermal mass 20 being on one side of the heat exchanger 48 and being directed through one of the coolant loops 32 and 36, and the other of the coolant loops 32 and 36 directing its coolant flow through the other side of the heat exchanger. As yet another option, the thermal mass 20 may include a phase-change material (PCM), such as a eutectic salt, either alone or together with a volume of coolant, and either alone or together with an indirect contact heat exchanger 48. Preferably, the phase-change material would have a melting temperature selected to correspond to the desired operating temperature range of the fuel cell stack 12, and in a highly preferred form, the melting temperature is just below the desired operating temperature range of the fuel cell stack 12.

In operation, the fuel cell stack 12 transfers heat to the mixed coolant flow 30 which is then split into the two coolant flows 22 and 26 after exiting the fuel cell stack 12. The coolant flow 22 rejects heat to the thermal mass 20 in the reservoir 14 and then exits the reservoir 14 as the coolant flow 28 having a temperature T2 that is less than the temperature T1 of the coolant flow 26. The mixing valve 18 adjusts the relative proportions of the coolant flows 26 and 28 in response to the signal 42 from the sensor 40 so as to provide the mixed coolant flow 30 at a temperature T3 that will maintain the fuel cell stack 12 within its desired operating temperature range. Furthermore, heat is rejected from the thermal mass 20 to the coolant flow 24, which then rejects the heat in the radiator 16 before being directed back to the reservoir 14. Preferably, the radiator 16 operates continuously with a constant fan speed and coolant flow rate, thereby eliminating the need for an active control of the coolant loop 32. However, a low temperature fan cutoff could be provided to save energy during sustained periods of low stack load when the temperature within the reservoir 14 dips down near ambient air temperature. Preferably, the radiator 16 is sized to be larger than the average load cycle of the fuel cell stack 12. Periods of sustained high load during the operating cycle of the fuel cell stack should be accounted for through proper sizing of the radiator 16 and the thermal mass 20 in the reservoir 14. If the thermal mass 20 includes a phase-change material, the heat from the stack 12 would be dissipated in the reservoir 14 via phase-change, while the reservoir outlet temperatures from the reservoir 14 would remain at constant or nearly constant temperature. During periods of reduced loads, the radiator 16 would remove heat from the thermal mass 20, thereby returning the phase-change material to its original state.

The use of an indirect contact heat exchanger 48 can allow for the coolant flow through the coolant loop 36 to be isolated from the coolant flow through the coolant loop 32, which can be an advantage when the fuel cell stack 12 requires a “clean” coolant flow, i.e., a coolant flow that is free from ion contaminants, while the radiator can tolerate conventional coolants.

FIG. 2 shows an alternate embodiment of the fuel cell management system 10, with like components being numbered with like reference numbers in FIGS. 1 and 2. The system 10 of FIG. 2 differs form the system of FIG. 1 in that it utilizes a single coolant loop 50, rather than the two coolant loops 32 and 36 of FIG. 1, with the coolant flow 24 from the radiator 16 being supplied to the mixing valve 18 at a temperature T2. While this can allow for a somewhat simpler system in comparison to that of FIG. 1, it does not allow for the coolant flow to the stack 12 to be isolated from the coolant flow to the radiator 16. The system 10 of FIG. 2 can also optionally include a surge bottle 52.

It should be appreciated that while preferred embodiments have been shown in FIGS. 1 and 2, there are many possible modifications that remain within the scope of the invention. For example, while the position of the temperature sensor 40 is shown in FIGS. 1 and 2 for sensing the temperature of the coolant after it exits the stack 12, the temperature sensor 40 could also be placed so as to sense the temperature of the coolant flow 30 as it enters the fuel cell stack. Similarly, while the location of the pump 38 is illustrated on the outlet side of the fuel cell stack 12, it should be appreciated that the pump 38 could be placed at other locations, such as for example, between the mixing valve 18 and the inlet of the fuel cell stack 12.

It should be appreciated that the thermal mass 20 within the reservoir 14, coupled with the heat rejection from the radiator 16, can allow for the system 10 to accommodate transient power conditions, even when the heat generation of the fuel cell stack 12 increases or changes rapidly.

1. A fuel cell thermal management system for use in maintaining a fuel cell stack within a desired operating temperature range, the system comprising:
a fuel cell stack;
a thermal storage reservoir for storing thermal energy rejected from a coolant flow received from the fuel cell stack, the reservoir containing a thermal mass;
a radiator to reject heat from a coolant flow received from the thermal storage reservoir; and
a mixing valve connected to the fuel cell stack to receive a coolant flow at a first temperature therefrom, to one of the reservoir and the radiator to receive a coolant flow at a second temperature therefrom, and to the fuel cell stack to supply a mixed coolant flow at a third temperature thereto.

2. The fuel cell thermal management system of claim 1 further comprising:
a first coolant loop directing a first coolant flow through the radiator and the reservoir;
a second coolant loop directing a second coolant flow through the reservoir, the fuel cell stack, and the mixing valve; and
wherein the mixing valve receives the coolant flow at the second temperature from the reservoir.

3. The fuel cell thermal management system of claim 2 wherein each of the first and second coolant loops includes a coolant pump.

4. The fuel cell thermal management system of claim 2 wherein the reservoir further comprises an indirect contact heat exchanger for transferring heat between at least one of the coolant loops and the thermal mass.

5. The fuel cell thermal management system of claim 1 further comprising a coolant loop directing a common coolant flow through the radiator, the reservoir, the fuel cell stack, and the mixing valve, wherein the mixing valve receives the coolant flow at the first temperature from the radiator.

6. The fuel cell thermal management system of claim 1 further comprising a temperature sensor for sensing a temperature of a coolant flow exiting the fuel cell stack, and wherein the mixing valve is configured to adjust a composition of the mixed coolant flow in responsive to a signal from the temperature sensor.

7. The fuel cell thermal management system of claim 1 wherein the thermal mass comprises a phase-change material having a melting temperature selected to correspond to the desired operating temperature range.

8. The fuel cell thermal management system of claim 7 wherein the reservoir further comprises an indirect contact heat exchanger for transferring heat from a coolant flow to the phase-change material.

9. The fuel cell thermal management system of claim 1 wherein the thermal mass comprises liquid coolant that can mix with the coolant flow supplied to at least one of the radiator and the fuel cell stack.

10. The fuel cell thermal management system of claim 1 further comprising a fan to direct a cooling air flow through the radiator.

11. A fuel cell thermal management system for use in maintaining a fuel cell within a desired operating temperature range, the system comprising:
a fuel cell stack;
a thermal storage reservoir for storing thermal energy rejected from a first coolant flow received from the fuel cell stack, the reservoir containing a thermal mass;
a radiator to reject heat from a second coolant flow received from the thermal storage reservoir; and
a mixing valve connected to the fuel cell stack to receive a coolant flow at a first temperature therefrom, to the reservoir to receive a coolant flow at a second temperature therefrom, and to the fuel cell stack to supply a mixed coolant flow at a third temperature thereto.

12. The fuel cell thermal management system of claim 11 further comprising a first coolant loop directing a first coolant flow through the radiator and the reservoir; and a second coolant loop directing a second coolant flow through the reservoir, the fuel cell stack, and the mixing valve.

13. The fuel cell thermal management system of claim 12 wherein each of the first and second coolant loops includes a coolant pump.

14. The fuel cell thermal management system of claim 12 wherein the reservoir further comprises an indirect contact heat exchanger for transferring heat between at least one of the coolant loops and the thermal mass.

15. The fuel cell thermal management system of claim 11 further comprising a temperature sensor for sensing a temperature of a coolant flow exiting the fuel cell stack, and wherein the mixing valve is configured to adjust a composition of the mixed coolant flow in responsive to a signal from the temperature sensor.

16. The fuel cell thermal management system of claim 11 wherein the thermal mass comprises a phase-change material having a melting temperature selected to correspond to the desired operating temperature range.

17. The fuel cell thermal management system of claim 16 wherein the reservoir further comprises an indirect contact heat exchanger for transferring heat from a coolant flow to the phase-change material.

18. The fuel cell thermal management system of claim 11 wherein the thermal mass comprises liquid coolant that can mix with the coolant flow supplied to at least one of the radiator and the fuel cell stack.

19. A fuel cell thermal management method for maintaining a fuel cell stack within a desired operating temperature range, the method comprising the steps of:
transferring heat from a first coolant flow to a thermal mass;
transferring heat from the thermal mass to a second coolant flow;
rejecting heat from the second coolant flow;
mixing one of the first and second coolant flows with a third coolant flow from the fuel cell stack to create a mixed coolant flow;
transferring heat from the fuel cell stack to the mixed coolant flow; and
splitting the mixed coolant flow into the first coolant flow and the third coolant flow.

20. The method of claim 19 wherein the mixing step comprises adjusting the composition of the mixed coolant flow based on a sensed temperature representative of the fuel cell stack operating temperature.

21. The method of claim 20 wherein the step of transferring heat from a first coolant flow to a thermal mass comprises changing a phase of at least a portion of the thermal mass.

22. The method of claim 21 wherein the step of transferring heat from the thermal mass to a second coolant flow comprises changing a phase of at least a portion of the thermal mass.
